(19) United States
(12) Patent Application Publication
(10) Pub. No.: US 2013/0150193 A1
(43) Pub. Date: Jun. 13, 2013

(54) TOOTH-SKIPPING PREVENTION MECHANISM FOR DRIVING FORCE TRANSMISSION BELT

(71) Applicants: Yoshihiro FUKANO, Moriya-shi (JP); Shoichi Makado, Moriya-shi (JP); Masaki Imamura, Moriya-shi (JP)

(72) Inventors: Yoshihiro FUKANO, Moriya-shi (JP); Shoichi Makado, Moriya-shi (JP); Masaki Imamura, Moriya-shi (JP)

(73) Assignee: SMC Kabushiki Kaisha, Chiyoda-ku (JP)

(21) Appl. No.: 13/407,221

(22) Filed: Feb. 28, 2012

(30) Foreign Application Priority Data
Dec. 8, 2011 (JP) 2011-268478

(51) Int. Cl. F16H 7/18; F16H 7/02

(52) U.S. Cl. 474/148

(57) ABSTRACT

A tooth-skipping prevention mechanism includes a block, which is inserted displaceably into a first end block in an electric actuator. A cavity having a semicircular shape in cross section is formed in one end of the block facing toward an outer circumferential side of a drive pulley and recessed toward another end side of the block. In addition, the cavity is arranged at a predetermined distance with respect to an outer circumferential surface of a timing belt that is enmeshed with the drive pulley. When the timing belt is moved in a radial outward direction so as to separate away from the drive pulley, movement of the timing belt is restricted, whereby the enmeshed condition of the timing belt and the drive pulley is maintained.

### CROSS-REFERENCE TO RELATED APPLICATION

This application is based upon and claims the benefit of priority from Japanese Patent Application No. 2011-268478 filed on Dec. 8, 2011, of which the contents are incorporated herein by reference.

### BACKGROUND OF THE INVENTION

1. Field of the Invention

The present invention relates to a tooth-skipping prevention mechanism for a driving force transmission belt, which is used in a driving apparatus for imparting motion to a displaceable member by transmitting a rotary driving force of a driving element to the displaceable member through a driving force transmission belt that is enmeshed with a pulley, and which is capable of maintaining the enmeshed condition between the driving force transmission belt and the pulley.

2. Description of the Related Art

Heretofore, as a means for transporting workpieces or the like, a driving apparatus has been widely used, which is capable of transporting such workpieces by transmitting a rotary driving force of a rotary drive source such as a motor or the like to a transmission belt that is enmeshed with a pulley, and by linearly displacing a displaceable member, which is connected to the transmission belt.

In a driving force transmission means for transmitting a driving force using such a transmission belt, for example, as disclosed in Japanese Laid-Open Patent Publication No. 2010-173746, there is provided a tooth-skipping prevention member, which is disposed adjacent to a pulley with which the transmission belt is enmeshed. By abutment of the transmission belt against the tooth-skipping prevention member, the tooth-skipping prevention member acts to prevent disengagement of the enmeshed condition, when the transmission belt attempts to move toward an outer circumferential side and potentially become disengaged from the pulley, caused for example by abrupt load variations or the like from the rotary drive source.

### SUMMARY OF THE INVENTION

However, in the aforementioned conventional technique, for example, in the event that the teeth of the transmission belt and/or the pulley become worn, such that the state of engagement between the members changes and becomes shallow, the interval of separation between the tooth-skipping prevention member and the transmission belt cannot be adjusted, and therefore, it is easy for the transmission belt and the pulley to become disengaged from each other. In response to such a problem, it could be considered to prepare and attach another tooth-skipping prevention member of a different diameter responsive to the change in the enmeshed condition. However, in this case, the operation to exchange the tooth-skipping prevention member is troublesome and complex, and different plural tooth-skipping prevention members must be prepared beforehand.

A general object of the present invention is to provide a tooth-skipping prevention mechanism for a driving force transmission belt, which is capable of stably maintaining an enmeshed condition of the driving force transmission belt with respect to a drive pulley, and which can be adjusted easily even in cases where the enmeshed condition changes.

The present invention is characterized by a tooth-skipping prevention mechanism for a driving force transmission belt used in a driving apparatus, the driving apparatus being equipped with a drive pulley through which a rotary driving force of a driving member is transmitted, the rotary driving force being transmitted to a displaceable member through the driving force transmission belt that is enmeshed with the drive pulley, for thereby moving the displaceable member, wherein the tooth-skipping prevention mechanism comprises:

a displaceable body disposed in a body of the driving apparatus, which is displaceable in directions to approach and separate with respect to the drive pulley;

a guide member disposed on the displaceable body, which faces toward an outer circumferential surface of the driving force transmission belt;

an adjustment mechanism, which is capable of adjusting a distance of the displaceable body with respect to the drive pulley; and

a positioning member, which is capable of positioning a relative position of the displaceable body with respect to the driving force transmission belt,

wherein the guide member is arranged at a predetermined distance with respect to the driving force transmission belt.

According to the present invention, in a driving apparatus equipped with a drive pulley through which a rotary driving force of a driving member is transmitted, and in which the rotary driving force is transmitted to a displaceable member through a driving force transmission belt enmeshed with the drive pulley for thereby moving the displaceable member, a displaceable body is disposed in a body of the driving apparatus, which is displaceable in directions to approach and separate with respect to the drive pulley, and a guide member is provided on the displaceable body, which faces toward an outer circumferential surface of the driving force transmission belt. In addition, by means of an adjustment mechanism, the displaceable body is capable of adjusting a distance of the displaceable body with respect to the drive pulley, and further is capable of positioning the displaceable member with respect to the driving force transmission belt through a positioning member.

Accordingly, even if for some reason the driving force transmission belt moves in a direction to separate away from the drive pulley and potentially becomes disengaged therefrom, further movement of the driving force transmission belt is prevented by abutment of the driving force transmission belt against the guide member of the displaceable body.

As a result, movement of the driving force transmission belt away from the drive pulley is restricted, whereby disengagement of the driving force transmission belt and the drive pulley is prevented, and the state of engagement between the driving force transmission belt and the drive pulley can reliably be maintained.

Further, even in the event that the condition of engagement between the driving force transmission belt and the drive pulley changes, for example, due to wearing or the like, by displacing the displaceable body so as to approach toward or separate away from the drive pulley, and thus adjusting the distance between the guide member and the driving force transmission belt to a predetermined separation distance, the condition of engagement of the driving force transmission belt with respect to the drive pulley can reliably and stably be maintained, and such changes in the condition of engagement can easily be responded to without having to prepare different blocks having differing separation distances.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is an overall cross sectional view of an electric actuator to which there is applied a tooth-skipping prevention mechanism for a driving force transmission belt according to a first embodiment of the present invention;

FIG. 2 is an enlarged cross sectional view in the vicinity of a first end block in the electric actuator of FIG. 1;

FIG. 3 is a cross sectional view taken along line III-III of FIG. 2;

FIG. 4A is an enlarged cross sectional view showing the vicinity, in FIG. 3, of an enmeshed portion between a drive pulley and a timing belt;

FIG. 4B is a cross sectional view showing a condition in which the timing belt in FIG. 4A is displaced in a direction away from the drive pulley;

FIG. 5 is an overall cross sectional view of an electric actuator to which there is applied a tooth-skipping prevention mechanism according to a second embodiment of the present invention; and

FIG. 6 is a cross sectional view taken along line VI-VI of FIG. 5.

### DESCRIPTION OF THE PREFERRED EMBODIMENTS

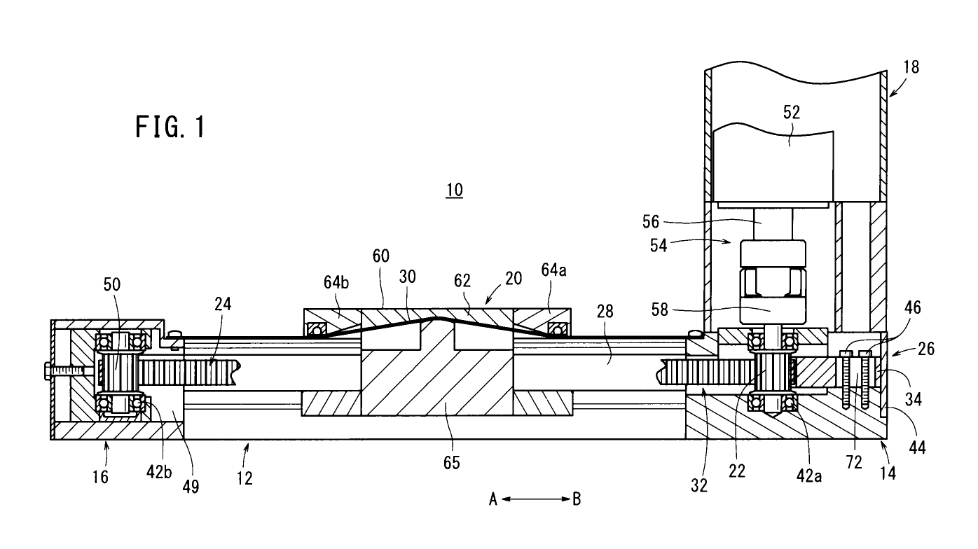

In FIG. 1, reference numeral 10 designates an electric actuator to which there is applied the tooth-skipping prevention mechanism for a driving force transmission belt according to a first embodiment of the present invention.

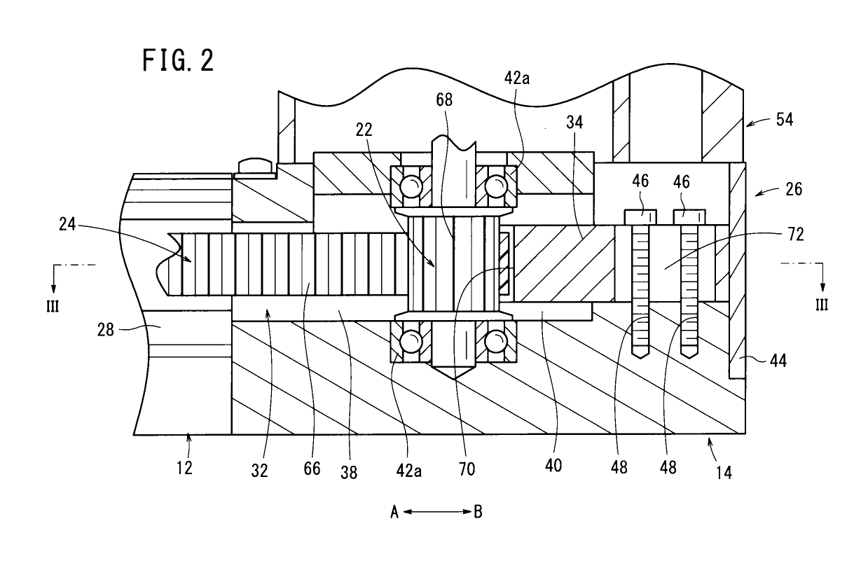

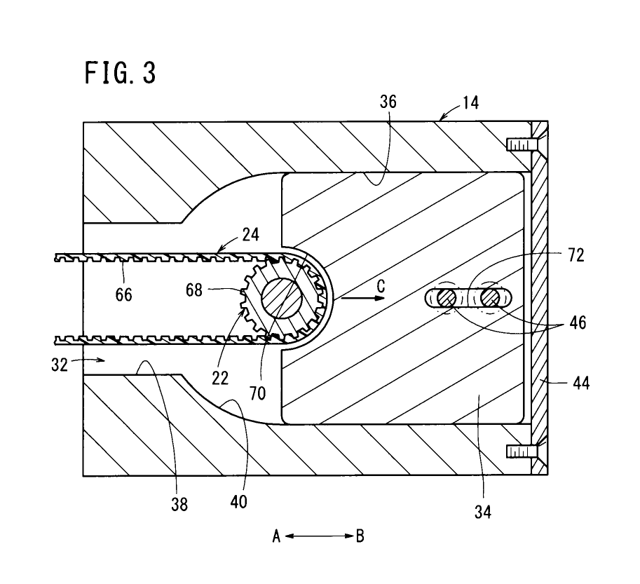

As shown in FIGS. 1 through 4B, the electric actuator (driving apparatus) 10 includes an elongate frame 12 that extends in an axial direction (the direction of arrows A and B), a pair of first and second end blocks 14, 16 connected to both opposite ends of the frame 12, a driving member 18, which is connected to the first end block (body) 14 and driven by an electric signal, a slider (displaceable member) 20 for transporting a workpiece (not shown), a timing belt (driving force transmission belt) 24 for transmitting a driving force to the slider 20 through a drive pulley 22 connected to the driving member 18, and a tooth-skipping prevention mechanism 26 that prevents disengagement of the enmeshed condition of the timing belt 24.

The frame 12 is formed to be hollow having a bore 28 in the interior thereof that extends along the axial direction (the direction of arrows A and B), and a slit (not shown) that opens along the axial direction is formed on an upper surface of the frame 12. A sealing belt 30 is attached to the slit, which performs a sealing function by blocking the slit from above.

The first and second end blocks 14, 16 are disposed respectively on opposite ends of the frame 12 so as to close and seal the open ends of the bore 28. The first and second end blocks 14, 16 are connected to the frame 12 through non-illustrated bolts.

The first end block 14, for example, is formed with a rectangular shape in cross section, and is connected to one end of the frame 12. The interior of the first end block 14 is formed with a first belt hole 32 connected to the bore 28 of the frame 12, and a block hole 36 communicating with the first belt hole 32, in which a block (displaceable body) 34 of the later-described tooth-skipping prevention mechanism 26 is displaceably provided.

The first belt hole 32 is equipped with a linear section 38 that extends at a constant width toward the side of the frame 12 (in the direction of arrow A) in the first end block 14, and a pulley accommodating section 40 formed at the end of the linear section 38 and having a semicircular shape in cross section.

The pulley accommodating section 40 is formed in a substantially central part of the first end block 14 and communicates with the block hole 36 while expanding in diameter in a radial outward direction with respect to the linear section 38, and is formed with a diameter substantially the same as the width dimension of the block hole 36.

In addition, the drive pulley 22 is axially supported rotatably via a pair of bearings 42a in the pulley accommodating section 40, and the timing belt 24 is trained around the drive pulley 22.

The block hole 36 extends at a substantially constant width in the direction (the direction of arrow B) away from the first belt hole 32, the end thereof penetrating through an opening at an end surface of the first end block 14. More specifically, the block hole 36 extends substantially along the same axis as the first belt hole 32. In addition, the block hole 36 is closed and blocked by a cover member 44 that is mounted on the end surface of the first end block 14. By removing the cover member 44, it is possible to take out and remove the block 34 from the block hole 36.

Further, a pair of bolt holes 48 are formed on the lower surface of the block hole 36, the bolt holes 48 being mutually separated from each other by a predetermined distance extending along the longitudinal direction (the direction of arrows A and B) of the block hole 36. Additionally, lock bolts 46 are screw-engaged in the bolt holes 48, which serve to regulate displacement of the block 34 in the axial direction (the direction of arrows A and B).

The second end block 16 is connected to the other end side (in the direction of arrow A) of the frame 12. A second belt hole 49, which is substantially rectangular shaped in cross section, is formed along the axial direction in the interior of the second end block 16. In addition, the timing belt 24 is inserted through the interior of the second belt hole 49. Furthermore, a driven pulley 50 is axially supported rotatably in the second bolt hole 49 through a pair of bearings 42b, with the timing belt 24 being trained around the driven pulley 50.

The driving member 18 includes a rotary drive source 52 made up, for example, from a stepping motor, and a joint 54, which is mounted on a lower part of the rotary drive source 52 and connected to the drive pulley 22 for transmitting a driving force to the drive pulley 22.

A drive shaft 56 of the rotary drive source 52 is connected to a joint member 58 of the joint 54. An end of the joint member 58 is connected to the drive pulley 22. In addition, the drive shaft 56 is rotated by an electric signal being input to the rotary drive source 52, and the rotary driving force therefrom is transmitted to the drive pulley 22 through the joint member 58, whereby the drive pulley 22 is rotated in the interior of the first end block 14.

The slider 20 includes a main body 62 having a table surface 60 on which a non-illustrated workpiece is mounted, a pair of end covers 64a, 64b mounted on respective opposite ends of the main body 62, and a yoke 65 that is connected to a lower part of the main body 62. Additionally, the sealing belt 30 is inserted between the main body 62 and the end covers 64a, 64b.

The yoke 65 is disposed for displacement along the bore 28 of the frame 12, one end and another end of the timing belt 24 being connected respectively to a side surface of the yoke 65.

The timing belt 24 is formed from an elastic material such as rubber or the like, and is suspended between the drive pulley 22, which is connected to the rotary drive source 52, and the driven pulley 50, which is supported rotatably in the interior of the second end block 16. Further, a plurality of parallel teeth 66 separated by predetermined intervals are formed on an inner circumferential surface of the timing belt 24. The timing belt 24 is made to go around the drive pulley 22 and the driven pulley 50 by the parallel teeth 66 thereof meshing respectively with teeth 68 of the drive pulley 22 and the driven pulley 50.

The tooth-skipping prevention mechanism 26 is equipped with the block 34, which is inserted displaceably in the first end block 14. The block 34 is made up from a block body formed with a dimension substantially the same as the width dimension of the block hole 36. In one end of the block 34, a cavity (guide member) 70 is formed that faces toward the outer circumferential side of the drive pulley 22, and which is recessed with a semicircular shape in cross section toward the other end (in the direction of arrow B) of the block 34.

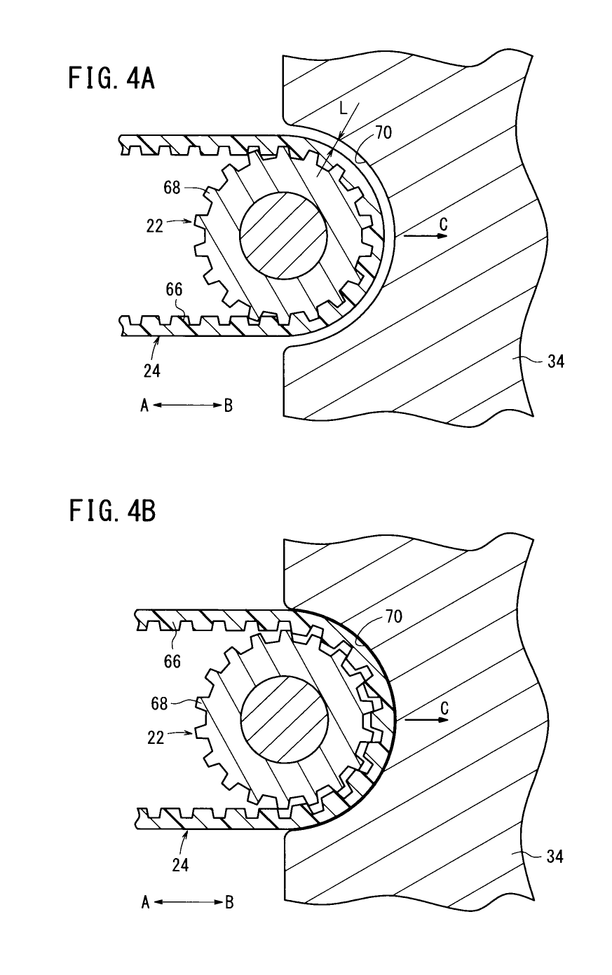

The radius of the cavity 70 is formed to be larger than the outer circumferential diameter of the timing belt 24 when the timing belt 24 is enmeshed with the drive pulley 22, and is arranged at a predetermined distance in a radial outward direction from the timing belt 24. More specifically, the cavity 70 is arranged so as to cover from the outer circumferential side the enmeshed location of the timing belt 24 with respect to the drive pulley 22, and further, is arranged in a condition having a predetermined interval clearance L (see FIG. 4A) with respect to the outer circumferential surface of the timing belt 24.

In greater detail, the clearance L between the cavity 70 and the timing belt 24 is set to be equal to or smaller than a movement distance, for a case in which the tooth tips of the parallel teeth 66 on the timing belt 24 ride on the tooth tips of the teeth 68 on the drive pulley 22, and the timing belt 24 moves in a direction (the direction of arrow C), i.e., in a radial outward direction, to separate away from the drive pulley 22, such that the parallel teeth 66 and the teeth 68 become released from engagement with each other.

More specifically, the clearance L is set based on the movement distance between the outer circumferential surface of the timing belt 24 in a normal condition of being enmeshed with the drive pulley 22, and the outer circumferential surface of the timing belt 24 in a condition in which the timing belt 24 moves in a direction (the direction of arrow C) away from the drive pulley 22 and the enmeshed condition thereof is released.

Further, an oblong hole 72 penetrates vertically at a longitudinal dimension along the axial direction (the direction of arrows A and B) on the block 34, and a pair of lock bolts 46 are inserted through the oblong hole 72. In addition, in a state of being inserted through the oblong hole 72, ends of the lock bolts 46 are screw-engaged respectively into bolt holes 48 of the first end block 14 that are formed beneath the oblong hole 72.

Owing thereto, after the block 34 has been moved in the axial direction and adjusted so that the aforementioned clearance L between the timing belt 24 and the cavity 70 is set at a predetermined distance, the pair of lock bolts 46 are screw-rotated and tightened, whereby the block 34 becomes gripped and firmly fixed in place between the first end block 14 and the lock bolts 46. As a result, positioning thereof is achieved, in which displacement in the axial direction (the direction of arrows A and B) of the block 34 is regulated.

The actuator 10 to which there is applied the tooth-skipping prevention mechanism 26 for a driving force transmission belt according to the first embodiment of the present invention is basically constructed as described above. Next, operations and advantages of the actuator 10 and the tooth-skipping prevention mechanism 26 shall be described.

First, an electric signal (e.g., a pulse signal) is output from a non-illustrated power source with respect to the driving member 18. Based on the electric signal, by rotation of the rotary drive source 52, the drive pulley 22 is rotated through the joint 54.

In addition, upon driving of the drive pulley 22, the driven pulley 50 on the other end side of the frame 12, which is connected thereto via the timing belt 24, is rotated integrally with the drive pulley 22. As a result, the yoke 65, which is connected to the timing belt 24, is displaced in the axial direction in the interior of the bore 28 in the frame 12, and together with the yoke 65, the slider 20 also is displaced along the frame 12 in the axial direction. At this time, upon displacement of the slider 20, the sealing belt 30 that seals the slit of the frame 12 is opened by one of the guide surfaces, and the opened sealing belt 30 is guided and made to approach toward the frame 12 again by the other guide surface, to thereby seal the slit.

On the other hand, by reversing the polarity of the electric signal input from the power source, the rotary drive source 52 is rotated in the opposite direction, whereby the slider 20, which is connected to the timing belt 24 through the yoke 65, is displaced in the opposite direction along the frame 12.

Next, a case shall be described in which the timing belt 24, which normally is enmeshed with the drive pulley 22, moves in a direction to separate from the drive pulley 22 and away from the enmeshed condition therewith in the first end block 14, for example, due to an abrupt load variation or the like to the drive pulley 22.

For example, in the case that an abrupt load variation occurs in the driving force that is imposed with respect to the drive pulley 22 from the driving member 18, along with a sudden increase in the rate of rotation of the drive pulley 22, the timing belt 24 becomes incapable of following, and as shown in FIG. 4B, slippage occurs in the enmeshed state of the timing belt 24 and the drive pulley 22. Together therewith, the timing belt 24 is moved in a direction (radial outward direction) to separate away from the drive pulley 22.

In this case, the cavity 70 in the block 34 of the tooth-skipping prevention mechanism 26 is disposed on the outer circumferential side of the drive pulley 22 and the timing belt 24, and therefore, as shown in FIG. 4B, by abutment of the outer circumferential surface of the timing belt 24 against the inner circumferential surface of the cavity 70, excessive movement of the timing belt 24 in the radial outward direction (the direction of arrow C) is prevented. At this time, because the movement amount of the timing belt 24 is set beforehand, by the clearance L between the timing belt 24 and the cavity 70, to a distance capable of maintaining the enmeshed condition of the parallel teeth 66 of the timing belt 24 and the teeth 68 of the drive pulley 22, by abutment thereof against the cavity 70, the enmeshed condition of the timing belt 24 with respect to the drive pulley 22 can reliably be maintained.

Stated otherwise, although the timing belt 24 moves in a direction (the direction of arrow C) away from the drive pulley 22, the tooth tips of the parallel teeth 66 and the tooth tips of the teeth 68 on the drive pulley 22 overlap in the circumferential direction, so that meshing engagement therebetween is not completely released. Therefore, the enmeshed condition of the parallel teeth 66 and the teeth 68 can reliably be maintained.

Further, in the case that enmeshment between the timing belt 24 and the drive pulley 22 becomes shallow, caused by abrasive wearing of the parallel teeth 66 of the timing belt 24 or the teeth 68 of the drive pulley 22, because the tooth tip diameters of the parallel teeth 66 and/or the teeth 68 become smaller in comparison to a case in which such wearing of the parallel teeth 66 and/or the teeth 68 has not occurred, the movement distance S of the timing belt 24 to a point where enmeshment between the parallel teeth 66 and the teeth 68 is released (i.e., the parallel teeth 66 and the teeth 68 become disengaged from each other) also becomes smaller.

Therefore, the block 34 is displaced toward the side of the drive pulley 22 (in the direction of arrow A) responsive to the aforementioned movement distance S, so that by making the clearance L between the cavity 70 of the block 34 and the timing belt 24 smaller, the enmeshed condition of the timing belt 24 with respect to the drive pulley 22 can reliably be maintained.

More specifically, because the block 34 is disposed so as to be displaceable in directions to approach and separate away from the drive pulley 22 and the timing belt 24, even if the condition of enmeshed engagement between the drive pulley 22 and the timing belt 24 changes, without the need for preparing different blocks, the block 34 can be moved and the clearance L adjusted, to thereby easily respond to changes in the condition of enmeshed engagement.

Further, to adjust the position of the block 34, the pair of lock bolts 46 are screw-rotated and loosened, and after the clearance L has been set by displacing the block 34 in the axial direction (the direction of arrows A and B), the lock bolts 46 are tightened. Thus, the position of the block 34 can be easily and reliably adjusted. Stated otherwise, the lock bolts 46 function as a positioning member, which is capable of positioning the block 34 in order to set the distance of the block 34 with respect to the drive pulley 22 and the timing belt 24.

Still further, the lock bolts 46 are inserted through the block 34, and by displacement of the block 34 along the oblong hole 72 elongate in the displacement direction (the direction of arrows A and B) of the block 34, the block 34 can easily be made to approach and separate away from the drive pulley 22 and the timing belt 24. Stated otherwise, the oblong hole 72 of the block 34 and the lock bolts 46 function as an adjustment means, which is capable of adjusting the separation distance (clearance L) of the block 34 with respect to the drive pulley 22 and the timing belt 24.

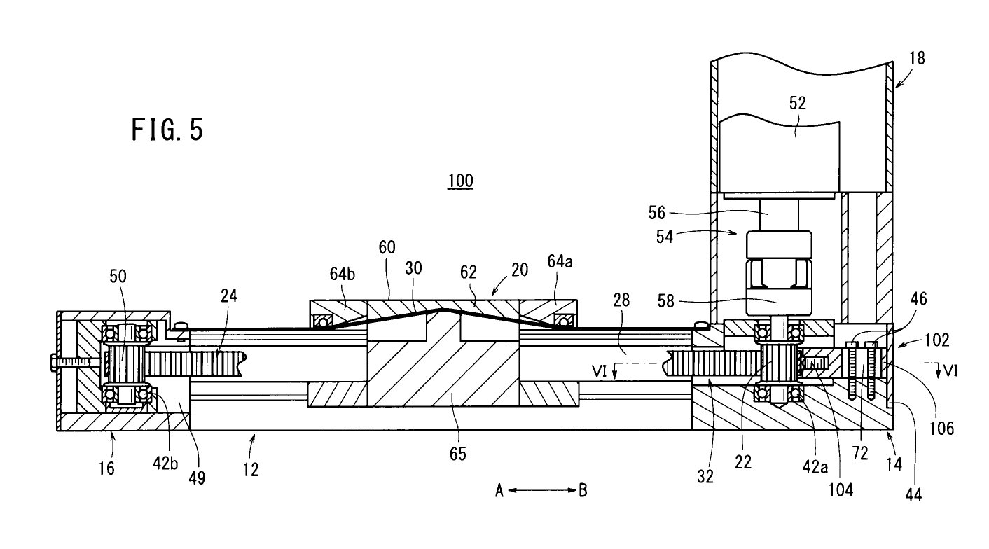

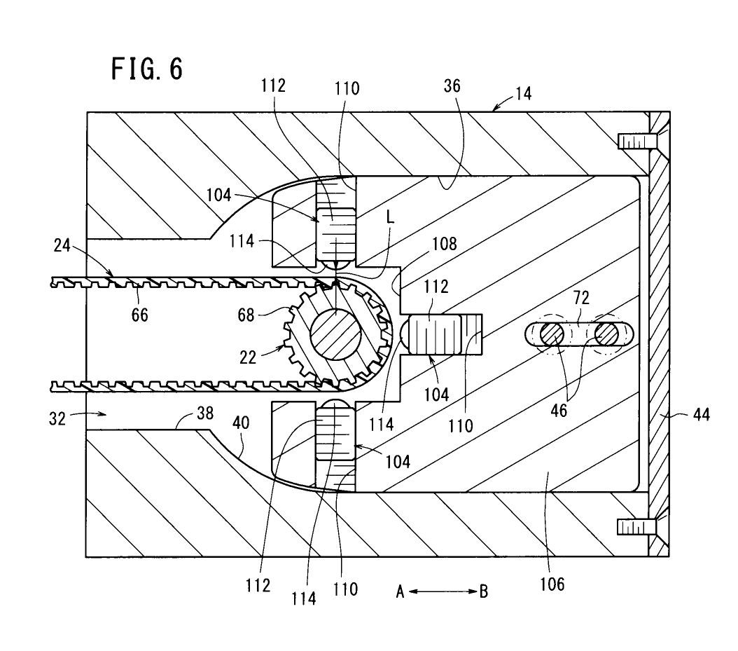

Next, an electric actuator to which there is applied a tooth-skipping prevention mechanism 102 for a driving force transmission belt according to a second embodiment is shown in FIGS. 5 and 6. Constituent elements, which are the same as those of the electric actuator 10 to which there is applied the tooth-skipping prevention mechanism 26 according to the above-described first embodiment, are designated by the same reference characters, and detailed description of such features is omitted.

The tooth-skipping prevention mechanism 102 for the driving force transmission belt 24 according to the second embodiment differs from the tooth-skipping prevention mechanism 26 according to the first embodiment, in that plural (for example, three) plungers (guide members) 104 that surround the outer circumferential side of the drive pulley 22 and the timing belt 24 are provided in a block 106.

As shown in FIGS. 5 and 6, the tooth-skipping prevention mechanism 102 is formed by a cavity 108, which is formed in one end of the block 106 facing toward the outer circumferential side of the drive pulley 22, and is recessed with a rectangular shape in cross section toward the other end side (in the direction of arrow B) of the block 106. The cavity 108 is disposed so as to cover the outer circumferential side of the timing belt 24, which is enmeshed with the drive pulley 22, with respective plungers 104 being disposed on inner side surfaces of the cavity 108.

Each of the plungers 104 is equipped with a holder 112, which is screw-engaged in a holder hole 110 of the block 106, and a ball 114, which is disposed rotatably on the end of the holder 112. The respective holders 112, by screw engagement therewith, are disposed to be capable of advancing and retracting along the holder holes 110, and to enable the clearances L between the timing belt 24 and the balls 114 provided on the ends of the holders 112 to be adjusted.

Further, the plungers 104 are arranged in the cavity 108 mutually perpendicular to each other, in the three directions. Stated otherwise, one of the plungers 104 is arranged substantially parallel to the direction of extension of the timing belt 24, whereas the remaining other two plungers 104 are arranged substantially perpendicular to the direction of extension of the timing belt 24, the plungers 104 further being arranged to confront and sandwich the timing belt 24 therebetween. More specifically, the plungers 104 are arranged so that the movement of the timing belt 24 in an enmeshed location with the drive pulley 22 can be regulated in three different directions by the tooth-skipping prevention mechanism 102.

The balls 114, for example, are formed from a resin material or a metallic material, and are arranged to face toward the outer circumferential surface of the timing belt 24, and to be separated a predetermined distance with respect to the outer circumferential surface. Clearances L between the plural balls 114 and the timing belt 24 are set substantially the same, respectively.

Further, the clearance L may be adjusted by displacing the block 106, or by adjusting each of the plungers 104 by advancing/retracting the plungers 104 within the holder holes 110, or adjustments may be performed by moving the aforementioned block 106 and the plungers 104 respectively.

In addition, in the case that the timing belt moves in a direction (radial outward direction) away from the drive pulley 22, for example, due to abrupt load variations with respect to the drive pulley 22 or the like, such that the timing belt 24 and the drive pulley 22 could potentially become disengaged from each other, the outer circumferential surface of the timing belt 24, which has moved in a direction (in the direction of arrow C) to separate from the drive pulley 22, comes into abutment against the plungers 104 of the tooth-skipping prevention mechanism 102, whereby further movement thereof in the radial outward direction is prevented. As a result, enmeshment of the timing belt 24 with respect to the drive pulley 22 can reliably and stably be maintained.

At this time, the movement amount of the timing belt 24 is set beforehand, by the clearance L between the timing belt 24 and the balls 114, to a distance capable of maintaining the enmeshed condition of the parallel teeth 66 of the timing belt 24 and the teeth 68 of the drive pulley 22. Thus, by abutment of the timing belt 24 against the balls 114, the enmeshed condition of the timing belt 24 with respect to the drive pulley 22 can reliably be maintained.

Further, by abutment of the timing belt 24 against the rotatably disposed balls 114 of the plungers 104, sliding resistance does not occur upon abutment, and resistance to rotation of the timing belt 24 can be prevented. As a result, even in the event that radial outward movement of the timing belt 24 is regulated by abutment against the plungers 104, the timing belt 24 can still rotate smoothly.

The tooth-skipping prevention mechanism for a driving force transmission belt according to the present invention is not limited to the embodiments described above, and it should be understood that various changes and modifications may be made to the embodiments without departing from the scope of the invention as set forth in the appended claims.

What is claimed is:

1. A tooth-skipping prevention mechanism for a driving force transmission belt used in a driving apparatus, the driving apparatus being equipped with a drive pulley through which a rotary driving force of a driving member is transmitted, the rotary driving force being transmitted to a displaceable member through the driving force transmission belt that is enmeshed with the drive pulley, for thereby moving the displaceable member, wherein the tooth-skipping prevention mechanism comprises:
a displaceable body disposed in a body of the driving apparatus, which is displaceable in directions to approach and separate with respect to the drive pulley;
a guide member disposed on the displaceable body, which faces toward an outer circumferential surface of the driving force transmission belt;
an adjustment mechanism, which is capable of adjusting a distance of the displaceable body with respect to the drive pulley; and
a positioning member, which is capable of positioning a relative position of the displaceable body with respect to the driving force transmission belt,
wherein the guide member is arranged at a predetermined distance with respect to the driving force transmission belt.

2. The tooth-skipping prevention mechanism according to claim 1, wherein the guide member is recessed in a semicircular shape in cross section corresponding to the outer circumferential shape of the driving force transmission belt which is enmeshed with the drive pulley.

3. The tooth-skipping prevention mechanism according to claim 1, wherein the guide member comprises a plunger having a ball that faces toward the outer circumferential surface of the driving force transmission belt, and which is rotated by abutment with the outer circumferential surface.

4. The tooth-skipping prevention mechanism according to claim 1, wherein a hole is formed in the displaceable body along a direction of displacement of the displaceable body, and the adjustment mechanism comprises a bolt fixed to the body and which is inserted through the hole, and
wherein the displaceable body is disposed displaceably via the hole through which the bolt is inserted.

5. The tooth-skipping prevention mechanism according to claim 1, wherein the positioning member comprises a bolt, which is inserted through a hole of the displaceable body and is fixed to the body, the displaceable body being gripped between the bolt and the body by tightening of the bolt.

6. The tooth-skipping prevention mechanism according to claim 2, wherein a clearance between the guide member and the driving force transmission belt is set smaller than a movement distance from an enmeshed position at which the driving force transmission belt is enmeshed with the drive pulley, to a position that the driving force transmission belt moves when tooth tips of teeth on the driving force transmission belt and tooth tips of teeth on the drive pulley run mutually on each other.

7. The tooth-skipping prevention mechanism according to claim 3, wherein a clearance between the guide member and the driving force transmission belt is set smaller than a movement distance from an enmeshed position at which the driving force transmission belt is enmeshed with the drive pulley, to a position that the driving force transmission belt moves when tooth tips of teeth on the driving force transmission belt and tooth tips of teeth on the drive pulley run mutually on each other.

8. The tooth-skipping prevention mechanism according to claim 1, wherein the driving apparatus comprises an actuator in which the driving force transmission belt is suspended between the drive pulley and a driven pulley arranged at a distance with respect to the drive pulley, and wherein the driving force transmission belt is connected to the displacement member.
